(19) United States
(12) Patent Application Publication
(10) Pub. No.: US 2021/0027238 A1
(43) Pub. Date: Jan. 28, 2021

(54) PRODUCT IDENTIFICATION SYSTEMS AND METHODS INCLUDING A SHELF

(71) Applicant: Touchcode Holdings, LLC, New York, NY (US)

(72) Inventors: Wayne L. Nemeth, Rye, NY (US); Lev M. Barsky, New York, NY (US); Oryan Inbar, Brooklyn, NY (US); Benjamin Kim, Rego Park, NY (US); Fredy Giovanni Uruchima, Brooklyn, NY (US); Vadakkedathu Thomas Rajan, Briarcliff Manor, NY (US)

(73) Assignee: Touchcode Holdings, LLC, New York, NY (US)

(21) Appl. No.: 16/870,340

(22) Filed: May 8, 2020

Related U.S. Application Data
(60) Provisional application No. 62/845,221, filed on May 8, 2019.

(51) Int. Cl. G06Q 10/08; A47F 5/00; B32B 27/36; G01G 3/14; G01G 19/00; G08B 7/06

(52) U.S. Cl. CPC G06Q 10/087; A47F 5/0043; B32B 27/36; G01G 3/14; G06Q 30/0185; G08B 7/06; B32B 2307/732; B32B 2250/04; B32B 2457/00; G01G 19/00

(57) ABSTRACT

Product identification systems and methods including a shelf are described herein.

### RELATED APPLICATIONS

This application claims priority to U.S. Provisional Patent Application Ser. No. 62/845,221 which was filed on May 8, 2019 and is incorporated herein by reference in its entirety.

### FIELD OF INVENTION

This application relates to product identification systems and methods including a shelf.

### SUMMARY

Product identification systems and methods including a shelf are described herein.

In one aspect, a system configured to display one or more products is provided. The system comprises a shelf. The shelf is configured to display one or more products. The system further comprises a multi-layer mat positioned on the shelf. The mat comprises at least a force sensing layer arrangement and a conforming layer configured to locally deform in response to one or more product(s) being placed on the shelf. The system is configured to identify the presence and/or type of product based at least in part on the force distribution sensed by the multi-layer mat.

In one aspect, a method of identifying a product placed on a display shelf is provided. The method comprises sensing the force distribution of the product placed on the display shelf using a multi-layer mat positioned on the shelf. The multi-layer mat comprises at least a force sensing layer arrangement and a conforming layer configured to locally deform in response to the one or more products being placed on the shelf. The method further comprises identifying the presence and/or the type of product based at least in part on the force distribution sensed by the multi-layer mat.

In some embodiments, the mat comprises a top protective layer and/or a bottom protective layer.

In some embodiments, the conforming layer is positioned above the force sensing layer arrangement; and, in other embodiments, the conforming layer is positioned below the force sensing layer arrangement.

In some embodiments, the force sensing layer arrangement includes a drive layer and a read layer.

In some embodiments, the mat is configured as a separable component from the shelf and is placed on the shelf to form the system; and, in other embodiments, the mat is an integral component of the shelf.

In some embodiments, the mat further comprises electrical circuitry that provides power and/or data to and from the mat.

In some embodiments, the mat further comprises a power supply arranged on the mat.

In some embodiments, the mat is trimmable. In some embodiments, the mat may be dimensionally configurable.

In some embodiments, the mat includes integrated electronics.

In some embodiments, the system comprises at least two mats positioned on the shelf.

In some embodiments, the system is configured to identify the type of product placed on two adjacent mats.

In some embodiments, the system further comprises an audio device configured to sound an alarm and/or announcement in response to an event. In some embodiments, the system further comprises a visual device configured to sound an alarm and/or announcement in response to an event.

In some embodiments, the system is configurable to detect movement of the product off the shelf and/or to another position on the shelf. In some embodiments, the system is configurable to count the number of products on the shelf.

In some embodiments, the system includes a plurality of shelves. The shelves may include include a multi-layer mat positioned on the shelf.

In some embodiments, the system is configured to identify the presence and/or type of product based at least in part on the weight distribution sensed by the multi-layer mat.

Other aspects and embodiments will become apparent from the following detailed description of the invention when considered in conjunction with the accompanying drawings.

### BRIEF DESCRIPTION OF THE DRAWINGS

FIG. 1 shows a multi-layer mat according to an embodiment.

FIG. 2 shows a mat including a conforming layer according to an embodiment.

FIG. 3 shows a physical arrangement of two adjacent mats.

FIG. 4 shows a virtual mat arrangement based on the two adjacent mats of FIG. 3.

FIG. 5 shows an FSR force vs. resistance curve according to an embodiment.

FIG. 6 shows an FSR layer arrangement according to an embodiment.

FIG. 7 shows an FSR sensor cell according to an embodiment.

FIG. 8 shows a is created using a circular bond using circles outlining the shape of a given footprint according to an embodiment.

FIG. 9 schematically shows the dismissed and retained data according to an embodiment.

### DETAILED DESCRIPTION

Product identification systems and methods including a shelf are described herein. The systems may include a mat which is positioned on a shelf (e.g., a shelf on which a product being solid is placed). In some embodiments, the mat comprises multiple layers and includes, for example, a conformable layer to distribute the weight of a product placed on the mat or other force transmitted through said product placed on the mat which may improve sensing of the product. In some embodiments, the mat includes flexible circuitry (e.g., for drive and/or read layers) which, for example, may enable the circuitry to wrap over the perimeter of the mat and to connect to other circuitry (e.g., control circuitry) positioned beneath the mats. In some embodiments, the mat itself is flexible, which can provide a number of advantages, including use with a larger variety of surfaces. In some embodiments, the mat is trimmable, which can provide a number of advantages, including use with surfaces of a variety of sizes. In some embodiments, the mat may include a thin top layer formed of a low-friction material which can provide a number of advantages including protection and providing a smooth and planar surface. In some embodiments, the mat may include one or more of graphics, text and other markings on the top layer which can provide a number of advantages including advertising and planogram compliance. The mats described herein can be used to identify products placed on the surface of the mat and can enable a variety of inventory management techniques.

It should be understood that the term “mat” as used herein may refer to a single physical unit of a “mat” or may refer to an assembly of mats. Also, one or more mats can be referred to as a “system of smart mats” or a “smart mat system.”

In some embodiments, the mat, or a portion thereof (e.g., at least 25%, at least 50%, at least 75%, or at least 90%) is flexible. In some embodiments, the flexibility of the mat facilitates placement on a variety of surfaces. For example, in some embodiments, the mat can be placed on rigid surfaces, non-rigid surfaces, flat surfaces, and/or non-flat surfaces.

In some embodiments, the mat, or a portion thereof (e.g., at least 25%, at least 50%, at least 75%, or at least 90%), is trimmable. Trimmable functionality, in some embodiments, facilitates placement of the mat on surfaces of a variety of sizes, which can be useful, as different stores or customers may have different needs. In some embodiments, the trimmable mat (or portion thereof) may have integrated electronics. In some embodiments, the trimmable mat (or portion thereof) may not have integrated electronics. In some embodiments, the mat is trimmed to the desired size at a factory. In some embodiments, the mat is trimmed to the desired size at the point of installation. In some embodiments, the mat can be trimmed to the desired size by the consumer.

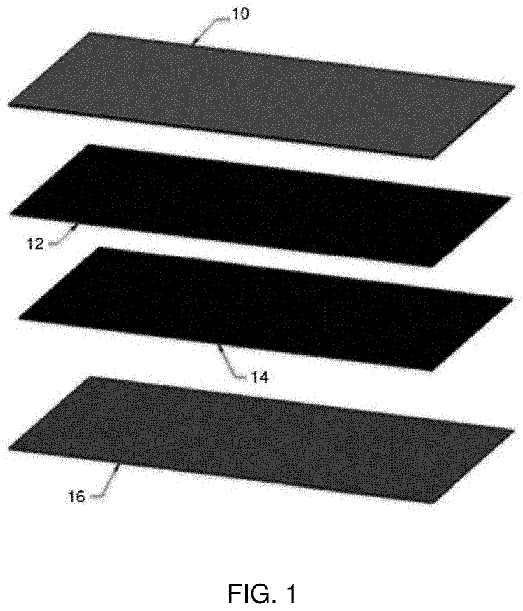

In some embodiments, the mat comprises multiple layers. For example, in some embodiments, the mat comprises at least 2 layers, at least 3 layers, or at least 4 layers. In some embodiments, the mat comprises less than or equal to 10 layers, less than or equal to 7 layers, or less than or equal to 4 layers. Combinations of these ranges are also possible (e.g., 2-4 layers). For example, as shown in FIG. 1, the mat may comprise 4 layers. In some embodiments, as shown in FIG. 1, the mat comprises top layer 10, a read layer 12, drive layer 14, and bottom layer 16. As described further below, in some embodiments, the read layer and the drive layer may form a force-sensing layer arrangement.

In some embodiments, the mat includes one or more conforming layers. In some embodiments, the conforming layer is the top layer. In some embodiments, the conforming layer is below the top layer. In some embodiments, the conforming layer is between top layer 10 and read layer 12. In some embodiments, the conforming layer is between drive layer 14 and bottom layer 16. In some embodiments, the conforming layer is above the bottom layer. In some embodiments, the conforming layer is the bottom layer. In some embodiments, there is more than one conforming layer in the various positions described herein. In some embodiments, there is no conforming layer.

In some embodiments, the mat has a thickness of less than ⅛ inch (e.g., between 1/16 inch and ⅛ inch) and, in some cases; the mat has a thickness of greater than 1/16 inch. In some embodiments, the conforming layer is the thickest layer of the mat. For example, the conforming layer may have a thickness of greater than 1/64 inch (e.g., between 1/64 inch and 1/16 inch, between 1/64 inch and 1/32 inch).

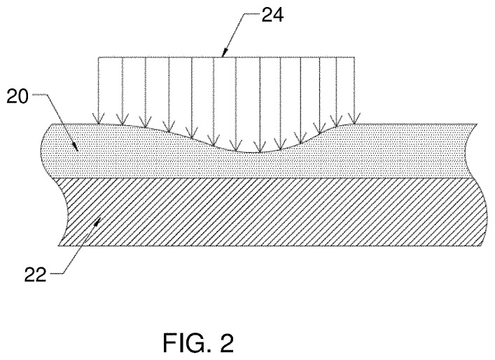

In some embodiments, the conforming layer may be used to help distribute the weight of an object (e.g., product) placed on the mat or other external force transmitted through the object placed on the mat to enable better characterization of the “footprint” of the object. Referring to FIG. 2, the mat may include a conforming layer 20 formed between the force-sensing layer arrangement 22 and an object 24 placed on the mat. The conforming layer may be on the force-sensing layer arrangement as shown in FIG. 2. In other embodiments, the confirming layer may be formed under the force-sensing layer arrangement. The object may be placed directly on the conforming layer; in some embodiments, on a layer (e.g., a top layer) that is formed on the conforming layer; or in other instances, a force concentrating device or fixture. As shown, the conforming layer can accurately distribute the weight of the object placed on the mat. That is, the conforming layer may be able to locally deform to give a more accurate representation of the distribution of the weight of the object across the mat. The conforming layer may be comprised of any suitable conforming materials such as foams (e.g., polymeric foams), gels, and elastomers (e.g., silicone) amongst others. The conforming layer may also be comprised of a flexible laminate having a liquid, gas or particulate material sealed therein.

It should be understood that the force-sensing stack-up may have a variety of different suitable designs and configurations in these embodiments. For example, the force-sensing layer arrangement may include a series of layers/materials that are combined to provide a sensor that is configured to detect (e.g., the presence of) an object. In some embodiments, the sensor is in the form of a film.

In some embodiments, the force-sensing layer arrangement may be based on force-sensing resistor (FSR) technology such that the resistance changes when a force or pressure is applied to the stack-up which would be experienced when an object (e.g., product) is placed on the mat. For example, the stack-up may include a matrix of FSRs. The FSRs may include a drive layer and a read layer. Suitable force-sensing configurations including FSR configurations that may be used in the mats described herein have been described in U.S. Patent Publication No. 2015-0041616, U.S. Patent Publication No. 2017-0234746, U.S. Pat. No. 5,031,463 and U.S. Pat. No. 5,220,971, each of which is incorporated herein by reference in its entirety.

In some embodiments, the force-sensing stack-up may be based on capacitive sensor technology. For example, such force-sensing stack-ups technology would utilize a matrix of conductors separated by a compressible dielectric layer, such as foam. The distance between the two conductors would affect capacitance in a linear fashion. Thus, the force-capacitance curve would be determined by the force-distance curve of the compressible layer.

In some embodiments, the force-sensing stack-up may be based on inductive sensing technology. In such embodiments, the force sensor may be implemented with two layers of inductive cells (e.g., printed coils connected to electronics with conductors), isolated by a compressible dielectric layer. In some embodiments, another top-layer sensor can be implemented individually or added to existing sensor technologies. For example, it is also possible to build an inductive version that would rely on detection of conductive ink coils printed on the packaging of items to be detected, or on detection of items made from materials that can be detected by inductive means (e.g., ferromagnetic materials).

In some embodiments, another inductive sensor implementation comprises a first layer of flat conductive coils printed thereon and a second layer having ferromagnetic properties (i.e., having a ferromagnetic material printed thereon) which are maintained at a specific distance (e.g., having an elastically compressible material in between). The sensor's construction allows for the separation distance to change in response to the placement or removal of an object on the sensor. An object placed on the sensor will cause the layers to move toward each other, thereby inducing a current in a specific direction in the coils of the first layer. An object removed from the sensor will result in the layers to move away from each other (and ultimately return to their preset separation distance), thereby inducing a current in the opposite direction. The detection of this induced current and its direction indicates the placement or removal of an object.

In some embodiments, the mat comprises supporting electronics (e.g., electrical circuitry). In some embodiments, the mat is protected from the environment to prevent unwanted electrical or mechanical interactions. For example, the mat may be protected from unwanted interactions with dust or liquids. This can be accomplished in several ways. For example, in some embodiments, the electrical circuitry, or a portion thereof (e.g., at least 25%, at least 50%, at least 75%, or at least 90%), are covered with a protective layer (e.g., as part of an integrated sensor package). In some embodiments, the electrical circuitry can be potted with a protective resin. In some embodiments, the electrical circuitry can be sealed with conformal coating. In some embodiments, the electrical circuitry can be sandwiched between sensors and sealed with heat and/or adhesives, such that the sensor substrate itself encapsulates the electrical circuitry and acts as a housing. In some embodiments, a protective film can be used to replace one or more of the sensor substrates.

In some embodiments, supporting electronics (e.g., electrical circuitry) run along the sensor. In some embodiments, electrical circuitry interface with the sensor. Examples of ways electrical circuitry may interface with a sensor include by crimp connects, FFC connectors, anisotropic conductive film (ACF) bonding, direct electromechanical contacts, and/or indirect electromechanical contacts. In some embodiments, the electrical circuitry are printed directly on the sensor, such that there is a direct interface between the electrical circuitry and the sensor with simplified interconnects. In some embodiments, the electrical circuitry that come into direct contact with the sensor are based on a repeating daisy-chained set of building blocks of circuitry. In some embodiments, the building blocks of electrical circuitry run a power and/or data interface to another set of electronics. Examples of ways the building blocks of circuitry may run a power and/or data interface to another set of electronics include by cables and/or connectors. This other set of electronics may, in some embodiments, be a processing unit. In some embodiments, a processing unit has the capacity to scan the sensor and process and/or transmit raw data.

In some embodiments, the electronics (e.g., electronic circuitry) of the mat are modular. For example, in some embodiments, the electronics of the mat are modular, such that the printed circuit board (PCB) and/or flexible print circuit (FPC) assemblies are of a desired minimum step of size adjustment, such that, for example, they can be used as basic electronics units for sensor operation. In some embodiments, the manufacturing facility and/or customer could interface the sensor of the desired size with the requisite number of basic electronic units necessary for the operation of a sensor of that size.

In some embodiments, the sensor, or a portion thereof (e.g., at least 25%, at least 50%, at least 75%, or at least 90%), is trimmable. In some embodiments, the electronics, or a portion thereof (e.g., at least 25%, at least 50%, at least 75%, or at least 90%), are trimmable. In some embodiments, the sensor and/or electronics are trimmed to the desired size at a factory. In some embodiments, the sensor and/or electronics are trimmed to the desired size at the point of installation. In some embodiments, the sensor and/or electronics are trimmed to the desired size by the consumer.

In some embodiments, the PCB assembly, or a portion thereof (e.g., at least 25%, at least 50%, at least 75%, or at least 90%), is trimmable. In some embodiments, the FPC assembly, or a portion thereof (e.g., at least 25%, at least 50%, at least 75%, or at least 90%), is trimmable. In some embodiments, the PCB and/or FPC assemblies are trimmed to the desired size at a factory. In some embodiments, the PCB and/or FPC assemblies are trimmed to the desired size at the point of installation. In some embodiments, the PCB and/or FPC assemblies are trimmed to the desired size by the consumer.

In some embodiments, trimmable components (e.g., the mat, sensor, electronics, PCB assembly, and/or FPC assembly) have a repeating daisy-chained pattern, such that they can be cut along the point of the daisy chain connection.

In some embodiments, the electrical circuitry, or a portion thereof (e.g., at least 25%, at least 50%, at least 75%, or at least 90%), is flexible. For example, the flexible electrical circuitry may be part of the layers that comprise the force-sensing stack-up (e.g., layers that comprise the FSR configurations). The flexible electrical circuitry may take the form of a portion of the circuitry that can be flexed to wrap over the perimeter of the mat. For example, the read layer and the drive layer of the force-sensing stack-up may include portions that can be wrapped around the perimeter of the mat and connected to a PCB on the backside of the mat. By including control circuitry (e.g., on a PCB) on the backside of the mat, this can lead to maximization of sensing area on the topside (i.e., sensing side) of the mat and minimization of non-sensing area which would otherwise need to be devoted to control circuitry (e.g., on a PCB). Such a configuration of positioning the control circuitry on the backside of the mat is particularly useful (e.g., in minimizing non-sensing zones) in embodiments which include multiple mats that are placed adjacent to each other and may be networked together.

In some embodiments, the flexible circuitry may be configured on the mat using techniques that involve heat and mechanical manipulation. For example, methods for wrapping circuitry (e.g., drive and/or read layer electrical connections) over the perimeter of the mat employ rapid controlled uniform heat application and mechanical manipulation to tightly form the flex circuitry over the mat.

As noted above, in some embodiments, the mat includes a top layer on which the objects are placed. The top layer may be positioned directly (or indirectly) on the conforming layer. The top layer may comprise a low-friction material such as a polyester (e.g., PET) film. The top layer may provide a number of advantages such as protecting the conforming layer from damage and providing a smooth surface on which objects placed on the mat can slide easily yet remain stationary at a high level of inertia when undisturbed.

In some embodiments, adjacent mats (e.g., two, three, four, etc.) may be configured to operate so that they jointly function as one continuous mat. In this sense, single physical mats may be virtually stitched together to function as a single continuous mat (e.g., the data from adjacent mats can be combined to produce a single sensor surface). Placing mats together can be useful to, for example, cover large areas.

In some embodiments, a single processing unit interfaces with a single mat. In other embodiments, a single processing unit may interface with multiple mats. In some embodiments, a single processing unit may interface with multiple mats that are in direct proximity (e.g., adjacent) to each other.

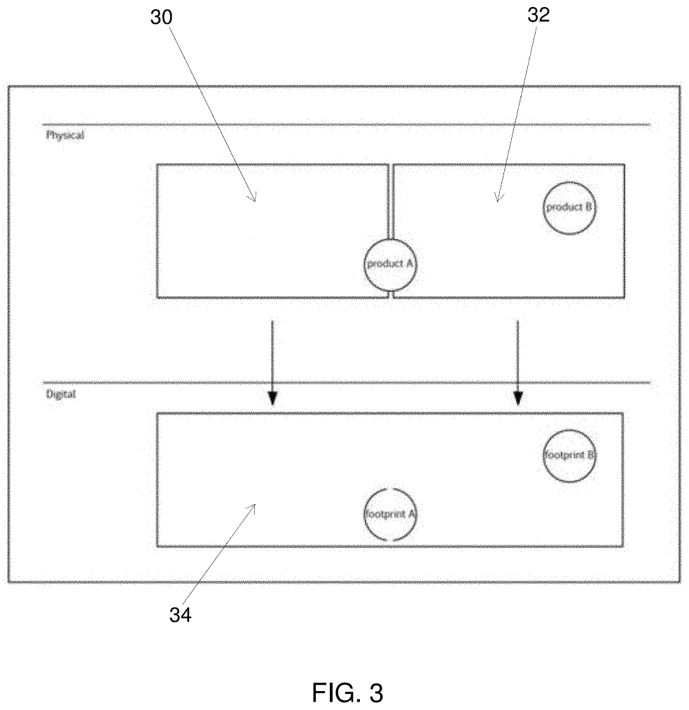

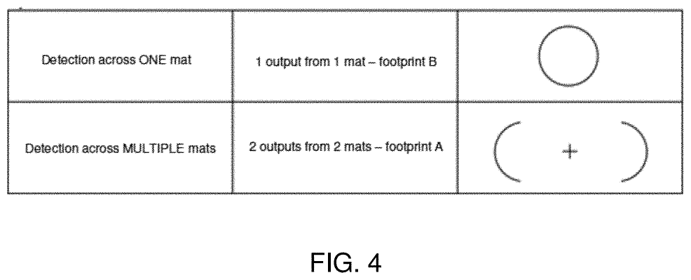

In some embodiments, such techniques enable detection of products that are placed on two adjacent mats. For example, techniques to detect products that are placed partly on two adjacent mats by joining (considering physical orientation and direction) the mat outputs together are shown in FIGS. 3 and 4.

In some embodiments, various techniques are implemented by a smart mat system to enable a user to configure a number of mats (or any portion(s) thereof) as a unit. For example, a detected group of like products may define the borders of one virtual mat comprising a set of multiple mats. Rules in turn can apply to the virtual mat.

In some embodiments, various planogram detection techniques are implemented by the smart mat system to automatically digitize a store by detecting products and their placement based on the final output from a set of multiple mats. The detected planogram is compared with the intended planogram for compliance and verification.

In some embodiments, certain calibration techniques are used to calibrate the mat to facilitate object detection. It should be understood that these calibration techniques may be used in connection with the mat designs described herein and other mat designs. These calibration techniques are not limited to the mat designs described herein. Various calibration techniques are described in U.S. Patent Publication Nos. 2015-0041616 and 2017-0234746, which are hereby incorporated by reference in their entireties.

In some embodiments that utilize an FSR layer, the calibration technique involves detecting damage. For example, in the event of either plastic deformation or destruction of the FSR layer, the resistance of a cell becomes, in the best case, too low to be of use, and in the worst, so low as to be potentially destructive. Hardware measures can be implemented to limit the current through a cell (e.g., current limiting resistors). In addition, current monitoring hardware (e.g., a current measurement resistor coupled to a comparator) can be used to detect dangerously high currents. Alternatively, software can monitor excessively low resistance values. In either implementation, software can subsequently ignore or altogether skip affected cells.

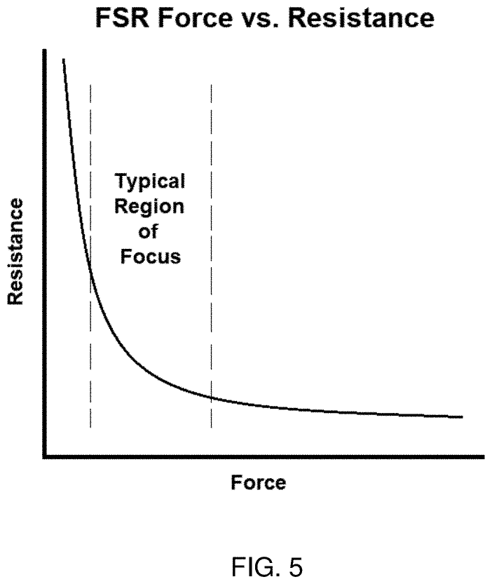

Referring to FIG. 5, as shown on the FSR force vs. resistance curve, the relevant transfer function is not linear. The most basic approach to this problem is to limit the useful range of the sensor and electronics to the most linear section of the curve. However, in some embodiments, that still may not result in a linear transfer function and can limit the useful dynamic range of the sensor.

In some embodiments, the method of calibration is to characterize a sensor by mapping the behavior of one or more cells in a given film or batch of films (e.g., by creating a device which could impart a known force on an isolated cell and read the resulting resistance or related value) and then using a microcontroller to linearize the curve.

In some embodiments, an advanced method of calibration may involve activating, mapping and subsequently linearizing every single cell in each mat. This could be done sequentially as in the example above but on every cell, or may be done simultaneously by, for example, a mat-sized plate or another means of imparting a physical force, such as a balloon. This more advanced calibration method can be used to account for: the variation in resistance from cell to cell; mechanical/assembly variation throughout the film; and variation between batches of film manufacture.

In some embodiments, a further advanced calibration method would use mapping for every cell described above. It would subsequently linearize the transfer function in a more advanced manner, by the means of linear algebra (i.e., a set of equations in a matrix) or data science, through calculating the impact of every cell on every other cell, thus eliminating the residual effects of sneak paths that cannot be fully eliminated by the differential drive methods implemented in hardware. This additionally more advanced calibration method can account for the sneak paths described in the set of concepts described further below.

As noted above, the systems and methods may identify the presence and/or type of product based at least in part on the force distribution (e.g., weight distribution) sensed by the multi-layer mat. In this context, the term “presence” refers to a situation in which products are present on the shelf as well as a situation in which products are absent from the shelf. In some cases, the systems and methods may be used to count the number of products on the shelf. In some cases, the systems and methods may be used to identify movement of product to a different position on the shelf or off the shelf. Certain suitable product detection techniques have been described in U.S. Patent Publication No. 2015-0041616, U.S. Patent Publication No. 2017-0234746 which are incorporated herein by reference in their entireties.

In some embodiments, the mat system comprises “smear detection” technology. Sensors have finite scan rates, such that a scan might occur in the middle of a change of input. For example, a customer might pick up a product from a mat right when the sensor is in the process of scanning that area, which might result in the sensor only detecting a portion of the product. As an alternative example, a product may be slid across a mat (e.g., during restocking) during a scan, which might result in a sensor detecting only a portion of the product, or detecting additional products that are not actually present. In some embodiments, the mat system utilizes “smear detection” technology as part of its algorithm to examine the stability of the image between scans. Using this algorithm, the mat system, in some embodiments, determines whether a scan is valid based on analysis of a set of scans. The mat system may, in some embodiments, determine whether a scan is valid (e.g., when less than a designated number of sensor points change less than a designated amount of a designated number of scans), invalid, or at a point of timeout (e.g., when stability is not reached within a designated time period). In some embodiments, the mat system may process and analyze the sensor data only when it is determined to be valid and/or at a point of timeout.

In some embodiments, other peripheral and/or integrated products/devices may be enabled by adding a new component to the mat system and/or products placed thereon. The resulting systems may include further functionality.

For example, in some embodiments, audio devices may be added to the mat system. Examples of audio devices range from a simple sounder to a message player to integration with a public address (PA) system. In some embodiments, the audio device can be activated as a result of a computational decision originating locally at the mat and/or after analysis by and/or feedback from a remote processing system (e.g., the cloud). In some embodiments, the computational decision would indicate that an event has taken place on the system, such as removal of a product from the system. Such embodiments may enable theft prevention techniques. For example, integration of the mat with audio devices may enable theft prevention techniques by drawing attention to the mat with an alarm and/or an announcement.

In some embodiments, visual devices may be added to the mat system. Examples of visual devices range from an LED light to cameras to video cameras to more complex imaging devices. In some embodiments, the visual device can be activated as a result of a computational decision originating locally at the mat and/or after analysis by and/or feedback from a remote processing system (e.g., the cloud). In some embodiments, the computational decision would indicate that an event has taken place on the system, such as removal of a product from the system. Such embodiments may enable theft prevention techniques. For example, integration of the mat with visual devices may enable theft prevention techniques by drawing attention to the mat with an LED and/or by taking a photo and/or video of the mat's surroundings to capture images of potential shoplifters. In some embodiments, such techniques may be designed to prevent second offenses (e.g., by capturing an image when it is determined that someone is likely stealing a product). Such embodiments may also enable customer recognition.

In some embodiments, other devices may be added to the mat system to facilitate the desired feedback or notification as a result of the computational decision. For example, a device could be added to the mat system such that a text message is sent to an appropriate person (e.g., the security team, the cashier, the sales representative, etc.) notifying him or her of the event, such as the removal of a product from the system.

In some embodiments, Bluetooth beacons may be added to the mat systems. For example, such beacons may enable mat-triggered interactivity. In some cases, an application is triggered on a smartphone of an individual to prompt him or her to perform an action (e.g., provide a coupon) in response to the individual's interaction with a product on a mat.

In some embodiments, a capacitive sensor (or portions thereof) may be added to objects placed on the mat. For example, a capacitive code may be added to a product (e.g., integrated into a label of a product) placed on the mat. In one representative use, a capacitive code is integrated into the label on a product so that it can be read by the mat to keep track of product expiration dates (and/or send alerts when products have expired). In some embodiments, a layer (e.g., a top layer) of the mat may include sensing features (e.g., printed coils for inductive sensing, dots or shapes for capacitive sensors) that can identify conductive elements (e.g., on the product). Such sensing features may be used to identify the location, pattern or shape of these conductive elements to act as either the primary or secondary means of identifying the product (e.g., the features may be the primary or only sensor that determines the identity of the product or the features may supplement the information that is gathered by another primary sensor such as an FSR matrix).

In some embodiments, a capacitive sensor is used to detect a code (e.g., the location of conductive ink dots) on the surface of the mat. This could be done with any of the traditional capacitive sensor implementations that are currently used on smart phones, for example. Suitable capacitive codes and techniques for manufacturing the same have been described, for example, in U.S. Pat. No. 8,497,850 which is incorporated herein by reference in its entirety.

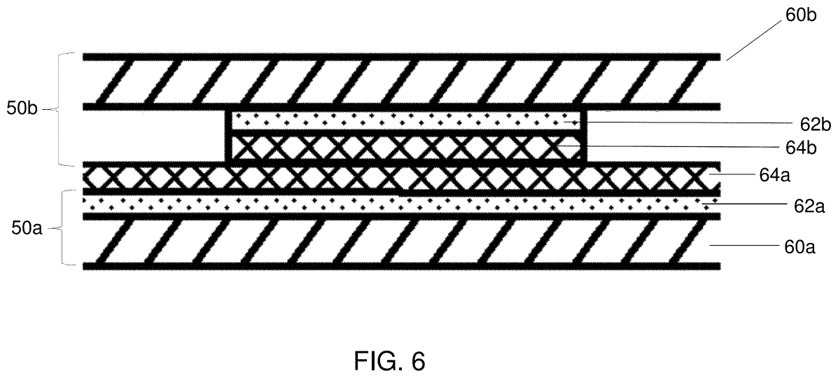

As described above, the force-sensing of the mat may be based on FSR technology in some embodiments. It should be understood that a number of different layer configurations may be used in such embodiments. In some cases, the FSR matrix (see FIG. 6 for a basic cutaway view according to an embodiment) is comprised of two films (50a, 50b) respectively referred to as the “drive side” and the “read side”. Each film comprises a non-conductive substrate (60a, 60b), a set of parallel conductors (62a, 62b), and an FSR compound layer (64a, 64b) deposited along said conductors. The two films may be arranged in a perpendicular manner, with the FSRs facing each other.

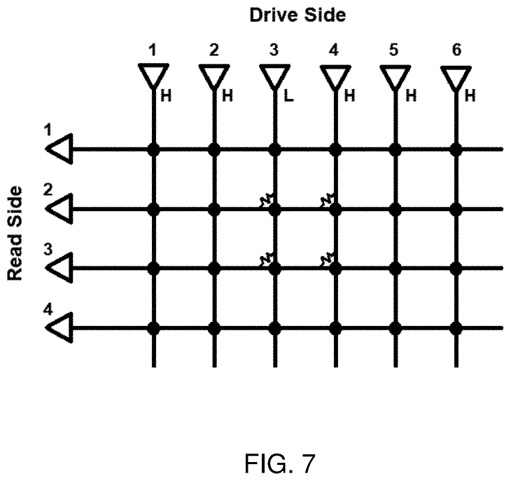

Referring to FIG. 7, each intersection of drive- and read-side FSRs constitutes a sensor cell. If the two FSRs are separated by a dielectric (e.g., air), their resistance can be considered infinite or otherwise negligible. Otherwise, the resistance of the FSRs will decrease with increasing force as determined by a non-linear transfer function.

In some embodiments, each line on the read side is connected to a “receiver” (i.e., specialized circuity intended to measure resistance and/or electrical current). These could be independent for each line, or there can be one or more of them connected to the read lines through a multiplexer (MUX) multiplexing circuitry. It should be understood that the precise electronics topology and product use case will combine to determine both the inherent prevalence of error signals and the capability of the electronics to attenuate them. In some embodiments, the most basic and obvious arrangement is to drive DC or AC (e.g., sinusoidal or square wave) current through a single drive line, while leaving the rest of the drive lines floating. However, in some cases, this may create a large error signal.

In FIG. 7 above, looking at the intersections, starting with the numbered drive side lines, followed by the numbered read side lines. In this case, cells D3:R2, D4:R2, D3:R3, and D4:R3 all have finite resistance (i.e., they are “pressed on” by an external force), whereas the rest of the cells have infinite or otherwise negligible resistance. If, for example, line D3 is the only driven line, and the electronics are reading line R2, the resistance detected is not only due to the current going through the intersection D3:R2, but also the additional (parallel) current going through the other three intersections with finite resistance. Thus, the overall detected resistance is lower and is affected by other cells that have force applied to them.

In some embodiments, a more advanced technique is utilized which involves driving every single inactive drive-side and/or read-side line. As illustrated in FIG. 7, the cell in focus is driven by one signal (labeled “L,” or low, in the attached drawing), while all the other drive-side lines are driven by the opposite signal (labeled “H,” or high, in the attached example, so as to simplify the presentation of the concept that the signals are intended to cause a flow of current through the sensor; actual parameters of both read and drive signals, such as the polarity, frequency, phase, etc., will be determined by the specific implementation). This arrangement may significantly reduce, though may not fully eliminate, the effect of the sneak paths on the observed resistance. The amount of reduction of the unwanted currents depends on the ratio of the output impedance of the drivers, the input impedance of the receivers, and the resistance of the cells in question, in combination with the number and locations of drivers and receivers with respect to active and inactive lines. Embodiments that allow for flexibility in combinations of these properties and techniques may therefore also allow for advanced methods of collecting sensor data, such as on-the-fly swapping of read and drive sides or observing a combination value of an entire row of column, which may subsequentially be processed to detect or otherwise account error signals with more accuracy.

In some embodiments, the mats described herein may be used in object detection and counting techniques. For example, two-dimensional data from a mat (e.g., from an FSR matrix) may be analyzed to identify and locate products in a smart mat system. The result may allow for a variety of information including inventory and shrinkage monitoring, theft detection, planogram compliance, etc. Such techniques may involve gathering data from the sensor (e.g., raw data received from the FSR matrix). The techniques may further involve filtering of noise using clustering techniques. For example, clustering techniques may be used to characterize noise patterns for a clean output. A pressure profile may contain noise characterized as a small, isolated number of non-zero measurements which correspond to resistance signals. Such noise also tends to have weak signal strength.

In some embodiments, geometric algorithms are utilized in object detection. For example, a hierarchical cluster is used to fit circles to clusters of adjacent cells. All circles that point toward each other are combined to obtain the boundary of a product. When a collection of circles close to each other form a convex shape, that shape is identified as a detected product.

In some embodiments, product classification and machine learning techniques are utilized. For example, the product classification process may rely on a machine learning model trained on known labeled data obtained while the system is in “learning mode.” Certain processes involve creating a model that requires the acquisition and labeling of a subset of the data by using known products and locations in a given data set from a mat. Such techniques may involve matching using templates (i.e. footprints) of a particular product from the labeled data (e.g., as described in Brunelli, R. “Template Matching Techniques in Computer Vision: Theory and Practice” which is incorporated herein by reference in its entirety). The number of templates used by the smart mat system may be enhanced by various augmentation techniques like rotating to create additional templates; combining selected templates (e.g., using symmetrical rotation if product shape is symmetric); convex hull (e.g., if product is convex).

Certain embodiments may involve machine learning techniques based on neural networks (e.g., as described in “Neural Networks and Physical Systems with Emergent Collective Computational Abilities” Proceedings of the National Academy of Sciences of the United States of America, 78(9) and Lecun Y., Cortes C. and Burges, C. J. (2013) MNIST handwritten digit database, both of which are incorporated herein by reference in their entireties). The templates may be also enhanced by techniques like rotating to create additional templates.

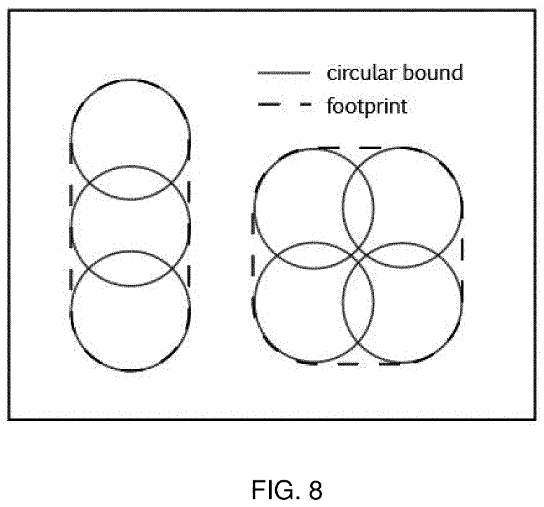

In some embodiments, the techniques involve establishing a footprint boundary by creating a container (“box”) that closely traces the shape of the product footprint to avoid the inclusion of parts of other footprints. The box is created using a circular bond using circles outlining the shape of a given footprint as shown in FIG. 8.

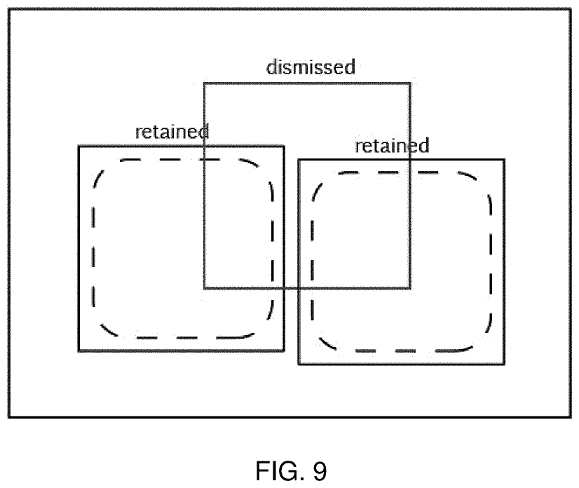

In some embodiments, the techniques involve filtering the resulting output by dismissing lower score matches that overlap with other higher score matches to ensure that only the highest scoring location of several overlapping locations is kept in the result as shown schematically in FIG. 9.

In some embodiments, a subtraction technique is used to prevent the data or signal of individual cells from being matched multiple times to the data contained in the templates. When the footprint is detected and identified with high confidence, then said individual cell data are removed from further consideration. If the removal of such data causes the number or the total sum of the data values in the bounding box of a footprint to be below a certain threshold, the match is considered invalid and removed.

In some techniques, a second pass of product classification as described above at a lower threshold is done recursively using the remnants as input. Any unclassified remnants may be further analyzed and filtered by the smart mat system to identify and locate other possible objects on the mat (e.g., lane aides such as pullers, lane dividers, front guards, etc.). In some cases, any unclassified remnants will be clustered and framed in order to identify and locate objects which the smart mat system has not yet been taught to recognize. Such objects are labeled as “unknown objects” at their respective locations and may add to the system's total count of items.

In some embodiments, a technique of using two images to compute a change in inventory may be used to improve the speed and accuracy of template matching and neural network techniques. For example, if a change in the values of the data is confined to a rectangular region within the mat, the data in that region can be sent to a classifier and used to detect the presence of a new product or absence of an previously present product. Since the region is smaller than the full mat, the speed of the classification is improved.

In some embodiments, a technique of reinforcement and feedback learning is utilized in which the system is trained on a generic model to start and then iteratively retrained with additional new data (e.g., as described in “Reinforcement Learning: A Survey”, Leslie Pack Kaelbling, Michael L. Littmen, and Andrew W. Moore, Journal of Artificial Intelligence Research 4 (1996) pp. 237-285 and “A Brief Survey of Deep Reinforcement Learning”, Kai Arulkumaran, Marc Peter Deisenroth, Miles Brundage and Anil Anthony Bharath, IEEE Signal Processing Magazine, November 2017, pp. 26-38, both of which are incorporated herein by reference in their entireties). The new additional data can be obtained via various methods and means including human audit and other external sensors such as a camera or a robot.

In some embodiments, scaling factors are used via the implementation of variable gain in the mat hardware. A low scaling factor (i.e., low gain) may be used when products placed on the mat are “heavier” (i.e., exert higher pressure on the sensor). A high scaling factor (i.e., high gain) may be used when the products are “lighter” (i.e., exert lower pressure). Having the possibility of scanning the mat at different scaling factors enables the detection, counting and/or recognition of a wider array of products.

In some embodiments, multiple images or collections of data from the mat from multiple signal driving and reading directions, perspectives or configurations may be used to improve the accuracy of object detection and recognition. When two distinct images are obtained from driving the mat from one side and then reversing the direction in which the current is sent so that data is gathered in the reverse direction, the two resulting images would contain: a) signals or data points corresponding to the pressure exerted on the mat by a product and b) signals or data points corresponding to anomalous or indeterminate sources; wherein the latter would differ between the two images. Thus, accuracy can be improved by retaining only the data points that are common to both images.

In some embodiments, a dynamic detection methodology is utilized. Such methods may include an adaptive mode that allows the system to determine detection methodology from a set of options:
Default Mode counts the precise number of objects on a mat (or any portion(s) thereof) when the objects have a distinct shape;
Light Product Mode changes the hardware settings if no distinct shape is found to allow for more sensitive sensing and then triggers the system to re-scan. New raw data is then fed to the product classification process. This cycle may repeat until the system successfully determines that identifiable items are present.
Mass Count Mode finds the total sum of the signal intensity from a mat (or any portion(s) thereof). This value provides a general indication of the inventory level when the shapes of the objects are amorphous and have no defined or repeatable footprint.

In some embodiments, instead of a mat, there may be a small tile. Suitable tiles have been described in U.S. patent application Ser. No. 16/740,606, which is incorporated herein by reference in its entirety. In some embodiments, the small tile comprises a single FSR film on a matrix of conductors. For example, in some embodiments, there is a PCB with exposed traces or traces printed on a film. It should be understood that any of the embodiments described for the mat may be used for the small tile.

It should be understood that any of the embodiments described above may be used alone or in connection with one another.

What is claimed is:

1. A system configured to display one or more products, comprising:
a shelf, wherein the shelf is configured to display one or more products; and
a multi-layer mat positioned on the shelf, wherein the mat comprises at least:
a force sensing layer arrangement; and
a conforming layer configured to locally deform in response to one or more products being placed on the shelf,
wherein the system is configured to identify the presence and/or type of product based at least in part on the force distribution sensed by the multi-layer mat.

2. A method of identifying a product placed on a display shelf comprising:
sensing the force distribution of the product placed on the display shelf using a multi-layer mat positioned on the shelf, wherein the multi-layer mat comprises at least a force sensing layer arrangement and a conforming layer configured to locally deform in response to one or more products being placed on the shelf,
identifying the presence and/or the type of product(s) based at least in part on the force distribution sensed by the multi-layer mat.

3. The system of claim 1, wherein the mat comprises a top protective layer.

4. The system of claim 1, wherein the mat comprises a bottom protective layer.

5. The system of claim 1, wherein the conforming layer is posited above the force sensing layer arrangement.

6. The system of claim 1, wherein the conforming layer is positioned below the force sensing layer arrangement.

7. The system of claim 1, wherein the force sensing layer arrangement includes a drive layer and a read layer.

8. The system of claim 1, wherein the mat is configured as a separable component from the shelf and is placed on the shelf to form the system.

9. The system of claim 1, wherein the mat is an integral component of the shelf.

10. The system of claim 1, wherein the mat further comprises electrical circuitry that provides power and/or data to and from the mat.

11. The system of claim 1, wherein the mat further comprises a power supply arranged on the mat.

12. The system of claim 1, wherein the mat is trimmable.

13. The system of claim 1, wherein the mat is dimensionally configurable.

14. The system of claim 1, wherein the mat includes integrated electronics.

15. The system of claim 1, wherein the system comprises at least two mats positioned on the shelf.

16. The system of claim 1, wherein the system is configured to identify the type of product placed on two adjacent mats.

17. The system of claim 1, wherein the system further comprises an audio device configured to sound an alarm and/or announcement in response to an event.

18. The system of claim 1, wherein the system further comprises a visual device configured to sound an alarm and/or announcement in response to an event.

19. The system of claim 1, wherein the system is configurable to detect movement of the product off the shelf and/or to another position on the shelf.

20. The system of claim 1, wherein the system is configurable to count the number of products on the shelf.

21-22. (canceled)
